(19) United States
(12) Patent Application Publication
(10) Pub. No.: US 2026/0119349 A1
(43) Pub. Date: Apr. 30, 2026

(54) STORAGE SYSTEM AND SYSTEM CONSTRUCTION METHOD

(71) Applicant: Hitachi Vantara, Ltd., Yokohama-shi (JP)

(72) Inventors: Takeru CHIBA, Tokyo (JP); Takahiro YAMAMOTO, Tokyo (JP); Taisuke ONO, Tokyo (JP); Katsuto SATO, Tokyo (JP)

(73) Assignee: Hitachi Vantara, Ltd., Yokohama-shi (JP)

(21) Appl. No.: 19/077,230

(22) Filed: Mar. 12, 2025

(30) Foreign Application Priority Data
Sep. 20, 2024 (JP) 2024-163512

(51) Int. Cl. G06F 11/20; G06F 11/16

(52) U.S. Cl. CPC G06F 11/2023; G06F 11/1612; G06F 11/2094

(57) ABSTRACT

A plurality of storage nodes constituting a first node group across a plurality of fault domains in a cloud environment are provided. For each node, a domain ID of a fault domain in which the node is generated is acquired, and a second node group is configured as a first node group from a necessary number of nodes whose domain IDs do not overlap as much as possible. The number of member nodes existing in the same fault domain in the second node group is equal to or less than the redundancy. The redundancy is the maximum number of member nodes allowed to stop simultaneously in the second node group. In the first node group, a node other than the second node group is a spare node that may be selected as a failback destination node.

### BACKGROUND OF THE INVENTION

### 1. Field of the Invention

The present invention relates to a storage system and a system construction method.

### 2. Description of the Related Art

In recent years, a cloud (particularly, a public cloud) is becoming widespread as a platform of an information processing system. In such a public cloud, a public cloud vendor provides computer resources and storage resources as infrastructure as a service (IaaS). In addition, there is an increasing demand for software defined storage (SDS) in order to increase the utilization efficiency of the storage capacity of the storage.

Generally, in an information processing system, a redundant configuration of a server device is employed to improve availability and reliability. For example, JP 2023-163298 A discloses a rebuilding method capable of quickly returning from a degenerate configuration when a failure occurs in an SDS built on a public cloud.

### SUMMARY OF THE INVENTION

When a plurality of storage nodes as virtual server apparatuses (virtual machine instances) are arranged in a storage system in a cloud environment, a cluster as a node group including two or more storage nodes operates. The cluster has a redundancy that means that processing (business) can be continued even if a certain number of storage nodes is stopped at the same time, and the cluster is down when a number of storage nodes exceeding the redundancy is stopped.

Storage node arrangement in the storage system is one of important elements for maintaining availability. Fault Domain (FD) can be cited as a point of view on the storage node arrangement. The FD is a set of hardware components (for example, a power supply, a server, or a storage device) that share a single point of failure, and is, for example, a power supply boundary or a rack.

A storage system having a plurality of fault domains is known. When any storage node in the cluster is stopped due to a node failure or the like, it is necessary to add a failback destination storage node operating instead of the stopped storage node and incorporate the added storage node into the cluster in order to recover the redundancy of the cluster. However, at least one of the following problems (a) and (b) may occur.
(a)When the failback destination storage node is added to the same FD as the existing storage node in the cluster, when a failure occurs in the FD, the plurality of storage nodes are simultaneously stopped. In a case where the number of stopped storage nodes exceeds the redundancy, the cluster is down.
(b)The FD serving as the addition destination may not have a margin for newly adding the storage node. As an example, it is conceivable that a storage node used by one or more users other than the user who uses the cluster is sufficiently arranged in the addition destination FD.

A plurality of storage nodes constituting a first storage node group across a plurality of fault domains in a cloud environment are provided. For each storage node, a domain ID of a fault domain in which the storage node is generated is acquired, and a second storage node group is configured as a first storage node group from a necessary number of storage nodes whose domain IDs do not overlap as much as possible. In the second storage node group, the number of member storage nodes existing in the same fault domain is equal to or less than the redundancy. The redundancy is the maximum number of member storage nodes allowed to stop simultaneously in the second storage node group. In the first storage node group, the storage node other than the second storage node group is a spare storage node that can be selected as the failback destination storage node.

According to the present invention, the availability of the storage system in the cloud environment can be appropriately maintained.

### BRIEF DESCRIPTION OF THE DRAWINGS

FIG. 1 is a block diagram illustrating an overall configuration of a storage system according to an embodiment;

FIG. 2 is a block diagram illustrating a schematic configuration of a storage node;

FIG. 3 is a block diagram for explaining software and configuration information stored in a memory of a storage node;

FIG. 4 is a diagram illustrating a configuration of a storage node management table;

FIG. 5 is a diagram illustrating a configuration of a cluster management table;

FIG. 6 is a block diagram for explaining PG creation;

FIG. 7 is a block diagram for explaining cluster creation;

FIG. 8 is a block diagram for explaining failover;

FIG. 9 is a block diagram for explaining redundant configuration recovery processing;

FIG. 10 is a block diagram for explaining state change processing;

FIG. 11 is a flowchart illustrating cluster construction processing according to an embodiment;

FIG. 12 is a flowchart illustrating redundant configuration recovery processing (at the time of a storage node failure);

FIG. 13 is a flowchart illustrating state change processing at the time of recovery of a failed storage node;

FIG. 14 is a block diagram illustrating another configuration of a cluster;

FIG. 15 is a block diagram illustrating a configuration of a cluster in a case where a spare FD is used;

FIG. 16 is a block diagram showing a configuration of a PG having a plurality of clusters; and

FIG. 17 is a block diagram illustrating an example in which a plurality of PGs straddle a plurality of common FDs.

### DESCRIPTION OF THE PREFERRED EMBODIMENTS

Hereinafter, an embodiment of the present invention will be described in detail with reference to the drawings. Note that the following description and drawings are examples for describing the present invention, and do not limit the technical scope of the present invention. In the drawings, common configurations are denoted by the same reference numerals.

In the following description, various types of information may be described with an expression such as “table ”, but various types of information may be expressed with a data structure other than these. The “XX table”, the “XX list”, and the like may be referred to as “XX information” to indicate that they do not depend on the data structure. In describing the content of each piece of information, expressions such as “identification information”, “identifier”, “name”, “ID”, and “number” are used, but these can be replaced with each other.

In addition, in the following description, in a case where the same kind of elements are described without being distinguished, reference numerals or common numbers in reference numerals may be used, and in a case where the same kind of elements are described while being distinguished, the reference numerals of the elements may be used, or IDs allocated to the elements may be used instead of the reference numerals.

In addition, in the following description, processing performed by executing a program may be described. However, the program is executed by at least one processor (for example, a CPU) to perform predetermined processing using a storage resource (for example, a memory) and/or an interface device (for example, a communication port) as appropriate. Therefore, the subject of the processing may be a processor. Similarly, the subject of the processing performed by executing the program may be a controller, a device, a system, a computer, a node, a storage system, a storage device, a server, a management computer, a client, or a host having a processor. The subject (for example, a processor) of the processing performed by executing the program may include a hardware circuit that performs a part or all of the processing. For example, the subject of the processing performed by executing the program may include a hardware circuit that performs encryption and decryption or compression and decompression. The processor operates as a functional unit that implements a predetermined function by operating according to the program. A device and a system including a processor are a device and a system including these functional units.

The program may be installed in a device such as a computer from a program source. The program source may be, for example, a program distribution server or a computer-readable storage medium. When the program source is a program distribution server, the program distribution server includes a processor (for example, a CPU) and a storage resource, and the storage resource may further store a distribution program and a program to be distributed. Then, when the processor of the program distribution server executes the distribution program, the processor of the program distribution server may distribute the program to be distributed to another computer. In the following description, two or more programs may be implemented as one program, or one program may be implemented as two or more programs.

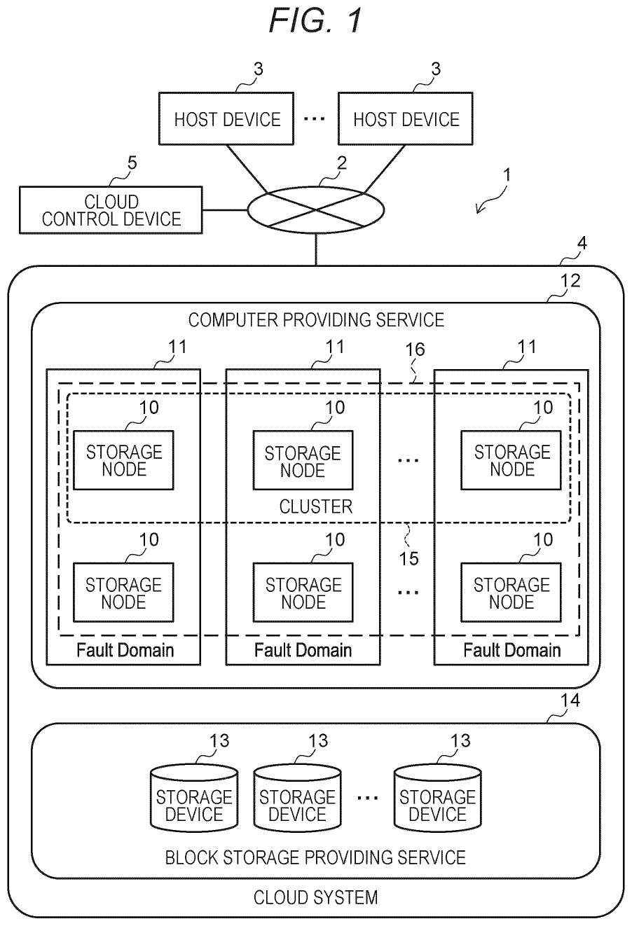

FIG. 1 is a block diagram illustrating an overall configuration of a storage system 1 according to an embodiment.

The storage system 1 may be a software defined storage (SDS) based on a cloud system 4. For example, a plurality of (or one) host devices 3, the cloud system 4, and a cloud control device 5 may be communicably connected to each other via a network 2 including Ethernet (registered trademark), a local area network (LAN), or the like.

The host device 3 is a higher-level device that transmits a read request or a write request (hereinafter, these are appropriately collectively referred to as an input/output (I/O) request) to a storage node 10 to be described later in the cloud system 4 in response to a user operation or a request from an implemented application program, and includes a general-purpose computer device. Note that the host device 3 may be a physical computer device or a virtual computer device such as a virtual machine. Further, the host device 3 may be incorporated in the cloud system 4.

The cloud system 4 is a system based on a cloud infrastructure (computer system) including a plurality of physical computers, and includes a computer-providing service 12 that provides a plurality of storage nodes 10 and a block storage-providing service 14 that provides a plurality of storage devices 13. Each storage node 10 can communicate with at least one of the plurality of storage devices 13 (for example, each storage device 13). The plurality of storage devices 13 may include one or a plurality of redundancy groups. The redundancy group includes two or more storage devices 13, and data is made redundant using a technology such as redundant array of independent (or inexpensive) disks (RAID) or erasure coding (EC). The storage device 13 may include one or more types of large-capacity nonvolatile storage devices. The storage device 13 may provide a physical or logical storage area for reading and writing data in response to an I/O request from the host device 3. In the present embodiment, the storage device 13 is a cloud block storage in the cloud system 4, but the present invention can also be applied to a storage system including a cloud system in which a storage other than the block storage is provided to a storage node. The non-volatile storage device may be, for example, an SAS SSD, an NVMe SSD, an SAS HDD, or an SATA HDD. SAS is an abbreviation for Serial Attached SCSI. SCSI stands for Small Computer System Interface. SSD stands for Solid State Drive. NVMe stands for Non Volatile Memory express. SATA stands for Serial ATA. ATA stands for Advanced Technology Attachment.

The storage node 10 is a virtual server device (virtual machine instance) that provides a storage area for reading and writing data from and to the host device 3. In practice, one or more storage devices 13 are allocated to each storage node 10. Then, the storage node 10 virtualizes the storage area provided by the allocated storage device 13 and provides the storage area to the host device 3.

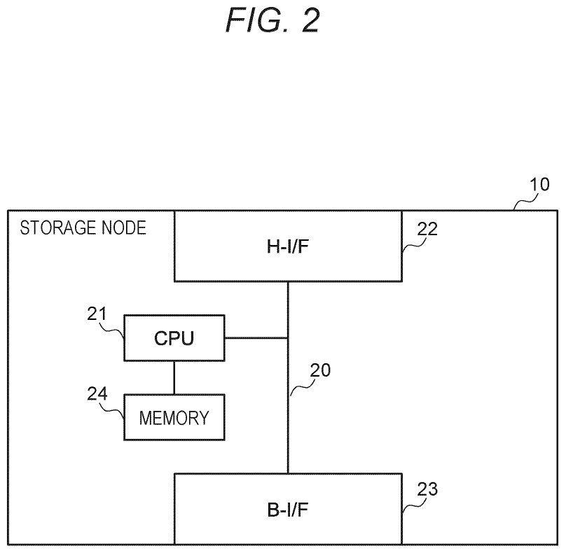

As illustrated in FIG. 2, the storage node 10 includes a central processing unit (CPU) 21, a host communication device (H-I/F) 22, and a block storage communication device (B-I/F) 23 connected to each other via an internal network 20, and a memory 24 connected to the CPU21. Each storage node 10 includes one or more CPUs 21, one or more H-I/Fs 22, one or more B-I/Fs 23, and one or more memories 24. Since the storage node 10 is a virtual server device, each of the CPU 21, the H-I/F 22, the B-I/F 23, and the memory 24 is a virtual device. These virtual devices may be based on a physical computer as an arrangement destination of the storage node 10.

The CPU 21 is a processor that controls the operation of the entire storage node 10. The memory 24 includes a volatile semiconductor memory such as a static random access memory (SRAM) or a dynamic RAM (DRAM), and is used to temporarily hold various programs and necessary data. At least one CPU 21 executes the program stored in the memory 24 to execute various processing as the entire storage node 10 as described later.

The H-I/F 22 is an interface for the storage node 10 to communicate with the host device 3, another storage node 10, or the cloud control device 5 via the network 2, and includes, for example, a network interface card (NIC). The H-I/F 22 performs protocol control at the time of communication with the host device 3, another storage node 10, or the cloud control device 5.

The B-I/F 23 is an interface for the storage node 10 to communicate with the storage device 13, and includes, for example, an NIC similarly to the B-I/F 23. The B-I/F 23 performs protocol control at the time of communication with the storage device 13.

The cloud system 4 includes a plurality of fault domains 11. Hereinafter, Fault Domain may be abbreviated as “FD”. The “FD” is a unit of a set of hardware components (for example, a power supply or a switch) sharing a single point of failure, that is, an independent hardware component set. The FD 11 is generally equivalent to a rack. If two or more storage nodes 10 are arranged in two or more different FDs 11, even if one FD 11 fails due to a power failure or the like, all of the two or more storage nodes 10 do not stop simultaneously. The FD 11 may be, for example, one or more physical computers.

One or more Placement Groups16 are set in the cloud system 4. Hereinafter, Placement Group may be abbreviated as “PG”. The “PG” is a group including a plurality of storage nodes 10. A boundary (typically, a power supply boundary or a rack boundary) according to the FD 11 in the PG 16 can be visualized for the user. Therefore, the user can know in which FD 11 the storage node 10 is arranged for each storage node 10 of the user. The PG 16 includes a plurality of storage nodes 10. A part of the storage nodes 10 of the PG 16 is an element of one or more clusters 15, and the remaining storage nodes 10 are spare storage nodes 10 not included in any cluster 15. When any storage node 10 in the cluster 15 is stopped (for example, stopped due to a failure), the spare storage node 10 can operate instead of the stopped storage node 10. The PG 16 may be an example of a first storage node group, and the cluster 15 may be an example of a second storage node group. “PG” may be Placement Group in AWS (registered trademark). Virtual Machine Scale Set of Azure (registered trademark) may be adopted as the first storage node group other than the PG. Which spare storage node 10 operates when any storage node 10 in the cluster 15 is stopped follows at least one of (p) and (q) below.

(p)In at least a part of the PG 16, a correspondence relationship (in other words, which spare storage node 10 operates when which storage node 10 is stopped) between the spare storage node 10 and the storage node 10 constituting the cluster 15 is determined in advance. The correspondence relationship is 1:1, many:1, 1:many, or many:many. According to this correspondence relationship, when any storage node 10 in the cluster 15 is stopped, the spare storage node 10 corresponding to the storage node 10 operates.

(q)In at least a part of the PG 16, the correspondence relationship between the spare storage node 10 and the storage node 10 constituting the cluster 15 is not determined in advance. When any storage node 10 in the cluster 15 is stopped, the spare storage node 10 selected arbitrarily (or according to a predetermined policy) operates. This selection may be performed by the cloud control device 5.

The cloud control device 5 is a general-purpose computer device having a function for a system administrator to control the computer-providing service 12 and the block storage-providing service 14 in the cloud system 4. The cloud control device 5 performs addition, deletion, configuration change, or the like of the storage node 10 and the cluster 15 in the computer-providing service 12 and the storage device 13 in the block storage-providing service 14 via the network 2 according to the operation of the system administrator. Note that the cloud control device 5 may be a physical computer device or a virtual computer device such as a virtual machine. Further, the cloud control device 5 may be incorporated in the cloud system 4.

The plurality of storage nodes 10 in the cloud system 4 may include only the storage node 10 for one user, but typically includes two or more storage nodes 10 for two or more users. For example, the plurality of storage nodes 10 may include two or more storage nodes 10 for user A (for example, company A) and two or more storage nodes 10 for user B (for example, company B).

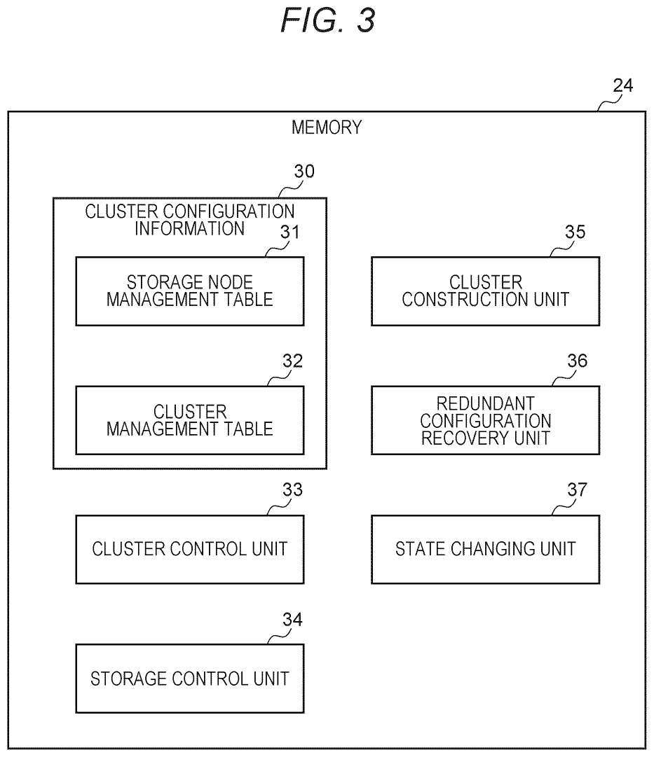

FIG. 3 is a block diagram for explaining software and configuration information stored in the memory 24 of the storage node 10.

The memory 24 stores software that is executed by the CPU 21 to implement functions such as a cluster control unit 33, a storage control unit 34, a cluster construction unit 35, a redundant configuration recovery unit 36, and a state changing unit 37. These functions 33 to 37 may be implemented by one piece of software, or may be implemented by a plurality of independent different pieces of software. Details of these functions 33 to 37 will be described later.

The memory 24 stores cluster configuration information 30 as configuration information. The cluster configuration information 30 may be, for example, a database, and includes a storage node management table 31 and a cluster management table 32.

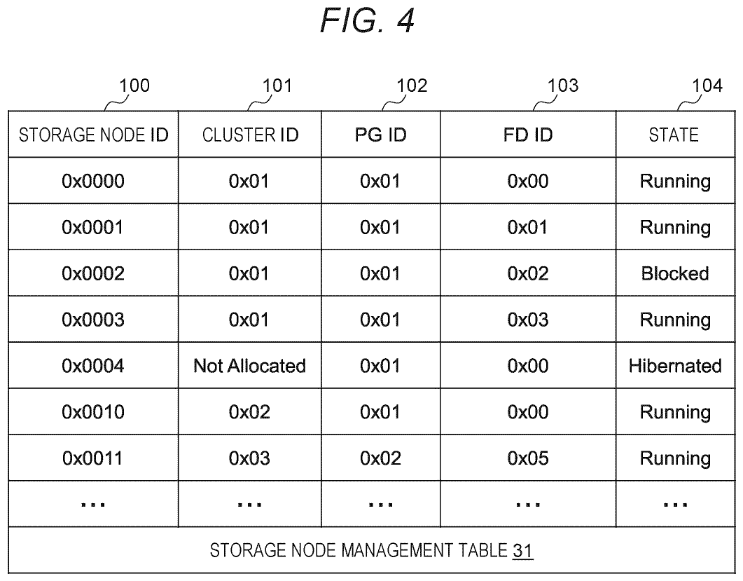

FIG. 4 is a diagram illustrating a configuration of a storage node management table 31.

The storage node management table 31 includes information on the storage node 10. The storage node management table 31 has a record for each storage node 10. Each record includes information such as a storage node ID 100, a cluster ID 101, a PG ID 102, an FD ID 103, and a state 104. Taking one storage node 10 as an example, the information 100 to 104 is as follows.

That is, the storage node ID 100 represents an ID of the storage node 10. The cluster ID 101 represents an ID of the cluster 15 including the storage node 10. The PG ID 102 represents an ID of the PG 16 including the storage node 10. The FD ID 103 represents an ID of the FD 11 in which the storage node 10 is disposed. The state 104 indicates a state of the storage node 10.

According to the example shown in FIG. 4, PG “0x01” includes a cluster “0x01” and a cluster “0x02”. Since the cluster ID 101 is “Not Allocated”, the storage node “0x0004” is a spare storage node 10 that is included in the PG “0x01” but is not included in any of the clusters “0x01” and “0x02”.

As the state 104, “Running” means in operation. “Blocked ” means that a fault is stopped. “Hibernated” means stopped. Note that, although the value representing the state of the storage node (virtual machine instance) and its meaning are different depending on the cloud vendor, in the present embodiment, a state in which the storage node 10 needs to be activated for the operation of the storage node 10 but can be held in a state where the holding cost is low is defined as “Hibernated” (stopped). The “Hibernated” storage node 10 may be in a state (for example, a power-off state) in which power consumption is lower than that in a state (for example, in sleep) in which power consumption is maintained so that the storage node 10 can be in operation in a relatively short time (for example, without requiring startup). According to another point of view, the state 104 “Hibernated” of the storage node 10 may be defined as a state in which the PG ID 102 and the FD ID 103 are allocated to the storage node 10 but the cluster ID 101 is not allocated thereto.

Each record of the storage node management table 31 may include, for example, information such as an instance type of the storage node 10 or a type of the storage device 13 allocated to the storage node 10 as further information.

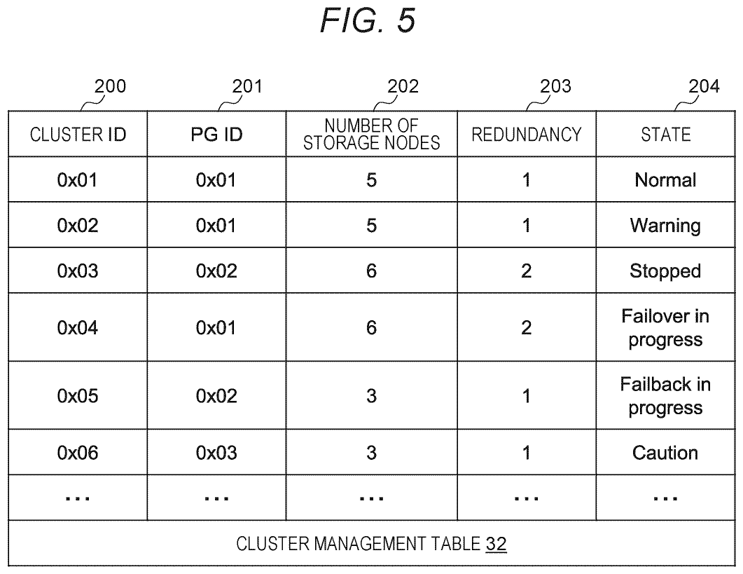

FIG. 5 is a diagram illustrating a configuration of a cluster management table 32.

The cluster management table 32 includes information on the cluster 15. The cluster management table 32 has a record for each cluster 15. Each record includes information such as a cluster ID 200, a PG ID 201, the number of storage nodes 202, a redundancy 203, and a state 204. Taking one cluster 15 as an example, the information 200 to 204 is as follows.

That is, the cluster ID 200 represents an ID of the cluster 15. The PG ID 201 represents an ID of the PG 16 including the cluster 15. The number of storage nodes 202 represents the number of storage nodes 10 included in the cluster 15. The redundancy 203 is a redundancy of the cluster 15, specifically, a maximum value of the number of storage nodes that can continue to operate even if a failure occurs in the cluster 15. Even if the storage nodes 10 of which the number is equal to or smaller than the number indicated by the redundancy 203 fail in the cluster 15 (stop), the processing (business) in the cluster 15 can be continued. The state 104 represents the state of the cluster 15. In each cluster 15, since the PG ID 201 and the number of storage nodes 202 are information that can be specified from the storage node management table 31, they may be omitted. Each of the one or more users may be notified of information (for example, a record of the cluster 15 including the storage node 10 allocated to the user) corresponding to the user in the cluster management table 32. The notification destination of the information may be the host device 3 or a management device (not illustrated).

According to the example illustrated in FIG. 5, the cluster “0x01” is included in PG “0x01” and includes five storage nodes 10, and the processing can be continued even if a failure occurs in one of the storage nodes 10.

As the state 204, “Normal” means normal. “Warning” means that failures are occurring in the number of storage nodes 10 equal to or less than the number indicated by the redundancy 203. “Stopped” means that a failure has occurred in more than the number of storage nodes 10 indicated by the redundancy 203, and the cluster 15 is stopped. “Failover in progress” means during failover. “Failback in progress” means during failback. “Caution” means that all the storage nodes 10 in the cluster 15 are normal, but there is a certain problem in the cluster 15. The “certain problem” may be, for example, that the cluster 15 is configured to be down due to a single FD failure due to failover, failback, or the like, or that there is no storage node 10 serving as a failback destination.

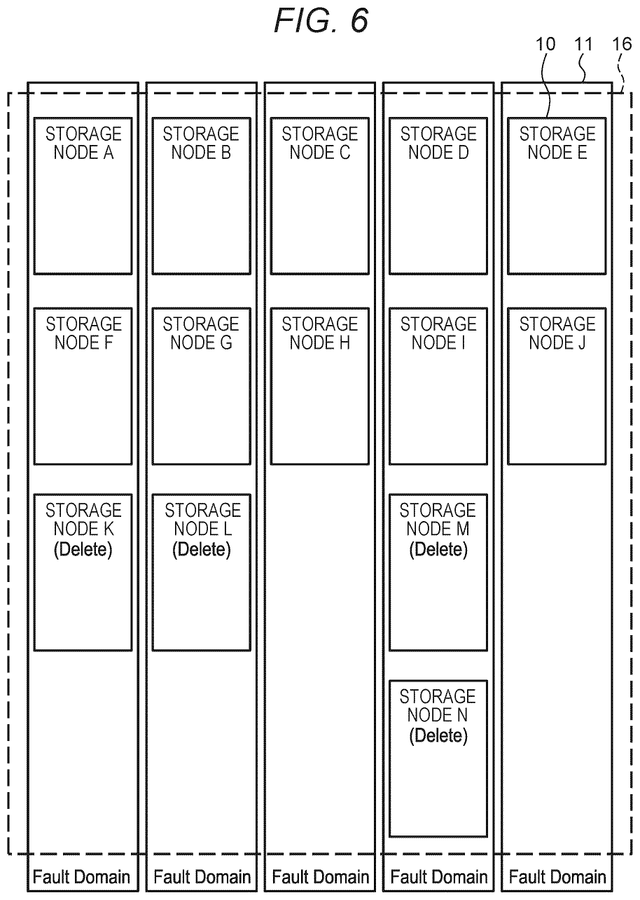

FIG. 6 is a block diagram for explaining PG creation.

An interface for receiving an instruction of PG creation is provided to the user (for example, the host device 3 or the management device) by the PG function of the cloud control device 5, for example, an instruction is received from the user via the interface, and in response to the instruction, PG 16 straddling the plurality of FDs 11 is created.

For example, acquisition of the FD ID of the FD 11 to which each storage node 10 belongs is continued until a certain criterion is satisfied. The “certain criterion” may be that a predetermined number or more of storage nodes 10 are secured in each FD 11, and for example, the processing continues until two or more storage nodes 10 are secured in each FD 11. Therefore, at least two storage nodes 10 are secured in each FD 11.

Thereafter, the PG 16 including the predetermined number or more of storage nodes 10 secured in each of the plurality of FDs 11 and straddling the plurality of FDs 11 is created. The storage node 10 unnecessary as a component of the PG 16 may be deleted or may exist as a component of the PG 16 without being deleted.

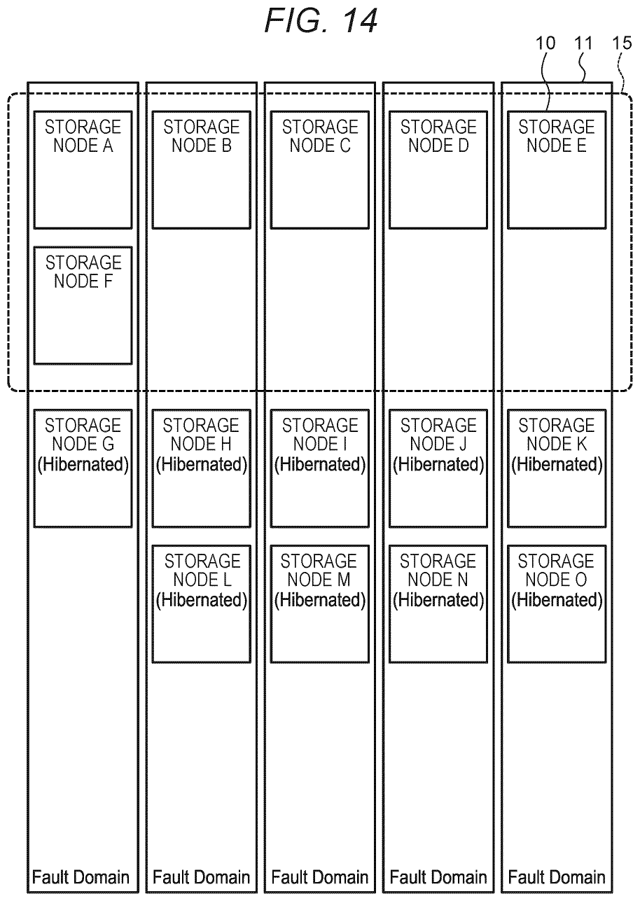

According to the example illustrated in FIGS. 6, 14 storage nodes A to N exist in the five FDs 11, the created PG includes 10 storage nodes A to J, and the other storage nodes K to N are deleted since they are unnecessary.

According to the PG function according to the present embodiment, the storage node 10 cannot be secured by designating the FD ID (that is, the PG function cannot receive the designation of the securing destination (arrangement destination) FD of the storage node 10). However, as a modification, the storage node 10 may be secured by designating the FD ID. In addition, according to the PG function according to the present embodiment, the storage node 10 secured in the FD 11 can know the FD ID of the FD 11 in which the storage node 10 exists. In addition, the FD ID may be a number of a physical rack (for example, a location in a data center) or a number of a relative index in the PG 16.

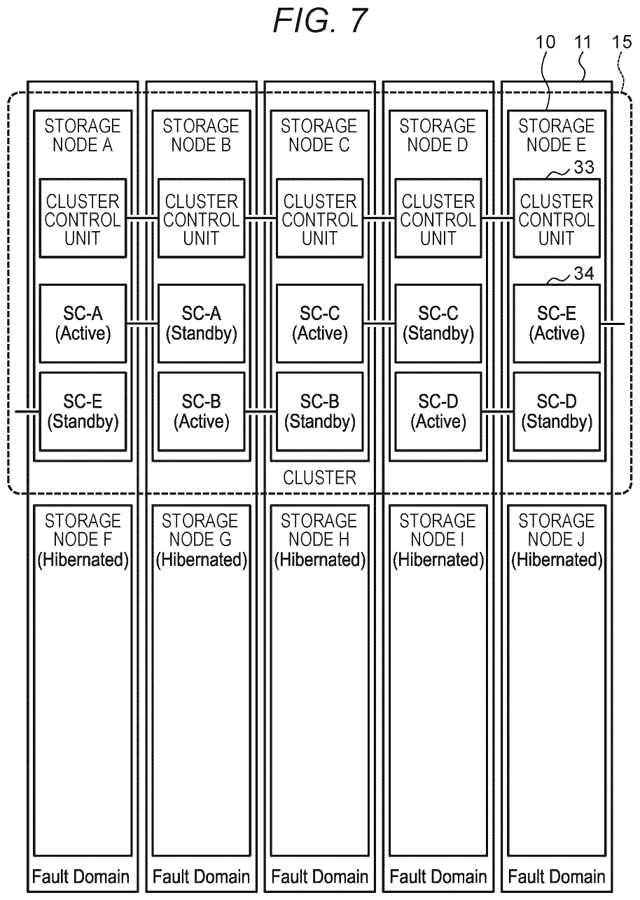

FIG. 7 is a block diagram for explaining cluster creation.

Two or more storage nodes 10 in the PG 16 are selected as elements (members) of the cluster 15, and the cluster 15 (Number of nodes “5”, redundancy “1”) is constructed by the two or more selected storage nodes 10. In the construction of the cluster 15, the cluster control unit 33 and the storage control unit 34 are constructed, the storage device 13 is attached to the storage node 10, and the like. The necessary number of storage nodes for the cluster 15 are selected such that the number of storage nodes aggregated in the FD 11 is equal to or less than the redundancy of the cluster 15, and the cluster 15 including the selected storage nodes is constructed. In the PG 16, each storage node 10 that has not been selected as an element of the cluster 15 has a state of “Hibernated”, that is, is in a stopped state.

In the example illustrated in FIG. 7, since the number of FDs is 5, the number of storage nodes required for the cluster configuration is 5, and the redundancy is “1”, one storage node 10 is selected from each FD 11. That is, among the storage nodes 10 included in the cluster 15, the number of storage nodes allowed to be aggregated (duplicated) to the same FD 11 is the redundancy “1” or less. In other words, among the storage nodes 10 included in the cluster 15, the number of storage nodes (in this example, at least two storage nodes) exceeding the redundancy “1” is prevented from being aggregated into one FD. As a result, the five storage nodes A to E existing in the five different FDs 11 are selected, and the cluster 15 is configured from the selected five storage nodes A to E. The states of the remaining storage nodes F to J are set to “Hibernated”.

In each storage node 10 in the cluster 15, the cluster control unit 33 and the storage control unit 34 are, for example, as follows. In the drawing, “SC” is an abbreviation of a storage control unit, and the storage control unit 34 may be abbreviated as “SC” in the following description.

The cluster control unit 33 manages or operates the state of each storage node 10 in the cluster 15. Specifically, for example, the cluster control unit 33 activates the storage control unit 34, detects a failure, or performs failover.

The storage control unit 34 functions as a storage controller in the storage node 10. For example, the storage control unit 34 performs I/O to the storage device 13 in accordance with an I/O request from the host device 3. The storage control unit 34 is redundant across M storage nodes 10 (M is an integer of 2 or more) in the cluster 15, and has an active-standby configuration. Specifically, a redundancy group across M storage nodes 10 is configured, and in the redundancy group, the state of one storage control unit 34 is “Active”, and the state of each of (M−1) storage control units 34 is “Standby”. In the illustrated example, M=2. Hereinafter, the redundancy group configured by SC-n (n=A, B, . . . ) may be referred to as a “redundancy group n”. The “redundancy” of the cluster 15 may be synonymous with the number of SC (Standby) in each redundancy group in the cluster 15. For example, when the redundancy group includes three SCs, specifically, one SC (Active) and two SCs (Standby), the redundancy of the cluster 15 is “2”.

In addition, a plurality of SCs (Active) in a plurality of redundancy groups may be distributed in a plurality of storage nodes 10 constituting the cluster 15. That is, a plurality of SCs (Active) in a plurality of redundancy groups may not be aggregated in a part (for example, one) of the storage nodes 10. As a result, the load is distributed to the plurality of storage nodes 10 (the plurality of FDs 11).

For each storage node 10, an access (I/O) to the storage device 13 attached (allocated) to the storage node 10 is processed by an SC (Active) in the storage node 10. For example, an access to the storage device 13 attached to the storage node A is performed by SC-A (Active).

When a failure occurs in the storage node 10 or the FD 11 and the SC (Active) stops, failover is performed. That is, the SC (Standby) is promoted to the SC (Active), the processing is handed over from the original SC (Active) to be stopped to the SC (Standby), and the SC (Standby) is promoted to the SC (Active).

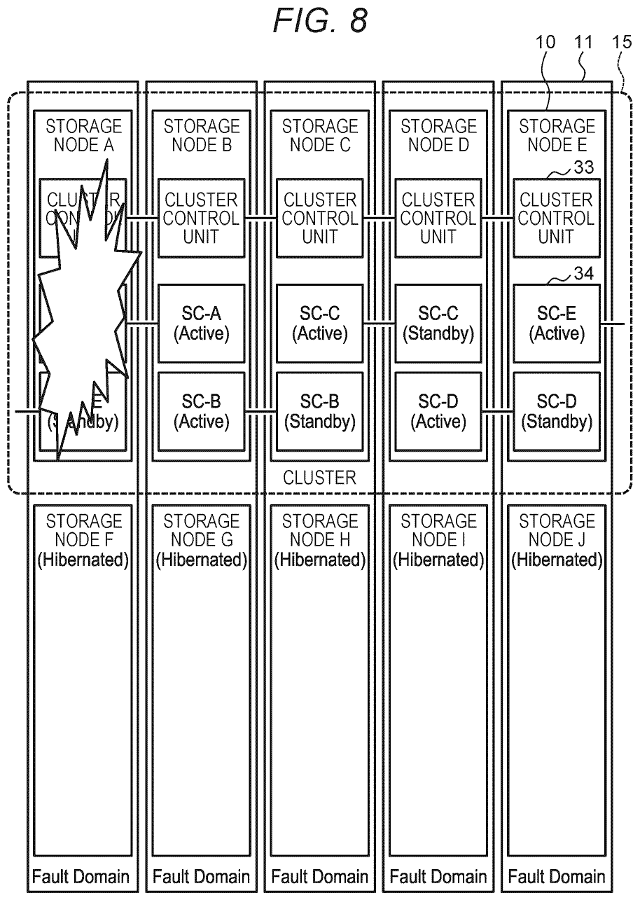

For example, as illustrated in FIG. 8, it is assumed that a node failure occurs in the storage node A. In this case, the processing is handed over from the active SC-A in the storage node A to the SC-A (Standby) in the redundancy group A, that is, the SC-A (Standby) in the storage node B, and the SC-A(Standby) in the storage node B is promoted to the SC-A(Active).

By the failover, the processing can be continued by an SC (Active) in the redundancy group in which the number of SCs is reduced. According to the example illustrated in FIG. 8, the redundancy groups in which the number of SCs is reduced are the redundancy groups A and E.

However, according to the example illustrated in FIG. 8, since the storage nodes 10 as many as the redundancy “1” of the cluster 15 are stopped due to the node failure, when the next node failure occurs in the storage node 10, the processing by the cluster 15 cannot be continued.

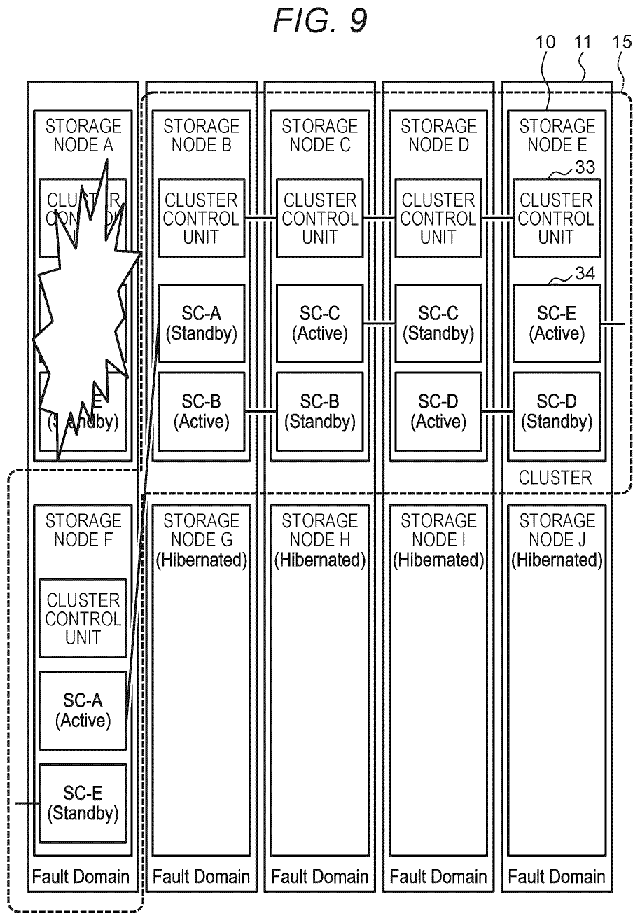

Therefore, as illustrated in FIG. 9, redundant configuration recovery processing (rebuilding & failback) in the cluster (5 nodes, 1 redundant) is performed. This processing is performed by at least the redundant configuration recovery unit 36 of the cluster control unit 33 and the redundant configuration recovery unit 36 in the representative storage node 10 described later.

Specifically, the representative storage node 10 (for example, among the storage nodes B to E other than the storage node A, the storage node 10 determined randomly or according to a predetermined rule) in the cluster 15 requests the cloud control device 5 to activate the storage node F existing in the FD 11 (here, the same FD 11 as the storage node A) different from the four FDs 11 in which the existing storage nodes B to E exist among the spare storage nodes F to J. In response to this request, the storage node F is activated by the cloud control device 5. For example, the state of the storage node F is changed from “Hibernated” to “Running”.

The representative storage node 10 detaches the storage device 13 allocated to the storage node A from the storage node A (releases the allocation of the storage device 13 to the storage node A), and requests the cloud control device 5 to newly attach the storage device 13 to the storage node F. In response to this request, the storage device 13 allocated to the storage node A is attached to the storage node F instead of the storage node A by the cloud control device 5.

Necessary information for incorporating the storage node F into the cluster 15 is copied to the storage node F, for example, from at least one of the other storage nodes B to E in the cluster 15 or from the storage device 13 attached to the storage node F. The cluster control unit 33 and the storage control unit 34 of the storage node F are activated, and the cluster configuration information 30 in each of the storage nodes B to F is updated.

Data in the storage device 13 attached to the storage node F is recovered to the latest information. For example, differential data, which is data updated after the storage device 13 is detached from the storage node A until the storage device is attached to the storage node F, is recovered. All data may be recovered on the basis of a general RAID technology, or an update area (updated block) may be specified using a differential bitmap or the like in the other storage nodes B to E, and only the updated area may be recovered.

Thereafter, the operation of the SC-A (Active) of the storage node B is handed over to the SC-A (Standby) of the corresponding storage node F, and the state of the SC-A of the storage node B is changed from “Active” to “Standby”.

By the above-described redundant configuration recovery processing, the redundancy decreased due to the node failure of the storage node A is recovered to the original redundancy “1”. In addition, although the SC (Active) is temporarily aggregated in the storage node B, the SC (Active) is redistributed.

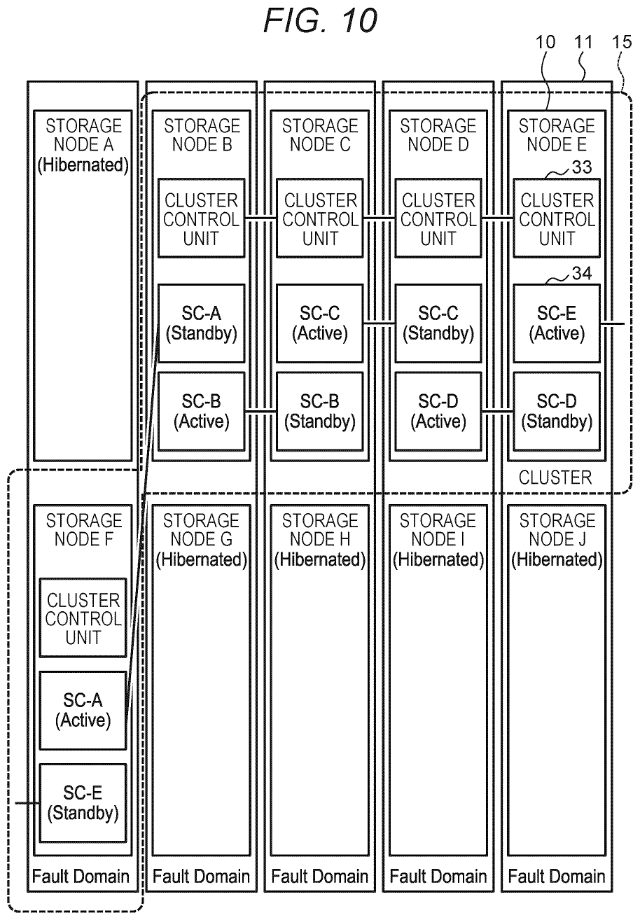

In a case where the storage node A is recovered after the redundant configuration recovery processing, the state of the storage node A is changed from “Blocked” to “Hibernated”, for example, as illustrated in FIG. 10. That is, the storage node A becomes one of the spare storage nodes 10 in the PG 16. Redundant configuration recovery processing in which the storage node A is incorporated into the cluster 15 instead of the storage node F may be performed, and the storage node F may become the spare storage node 10 (the “Hibernated” storage node 10) again.

In addition, in the redundant configuration recovery processing, when the storage node A is recovered before the storage node F is selected (for example, when the storage node A is temporarily stopped and recovered in a short time), the storage node A may be selected as the recovery destination instead of the storage node F.

In addition, in a case where a failure occurs in the storage node F before the recovery of the storage node A (before the state of the storage node A is changed to “Hibernated”), the storage node G may be selected as the recovery destination. In this case, two storage nodes 10 exist in the second FD 11 from the left as an element of one cluster 15, and the state 204 of the cluster 15 may be “Caution”.

Hereinafter, an example of processing performed in the embodiment will be described.

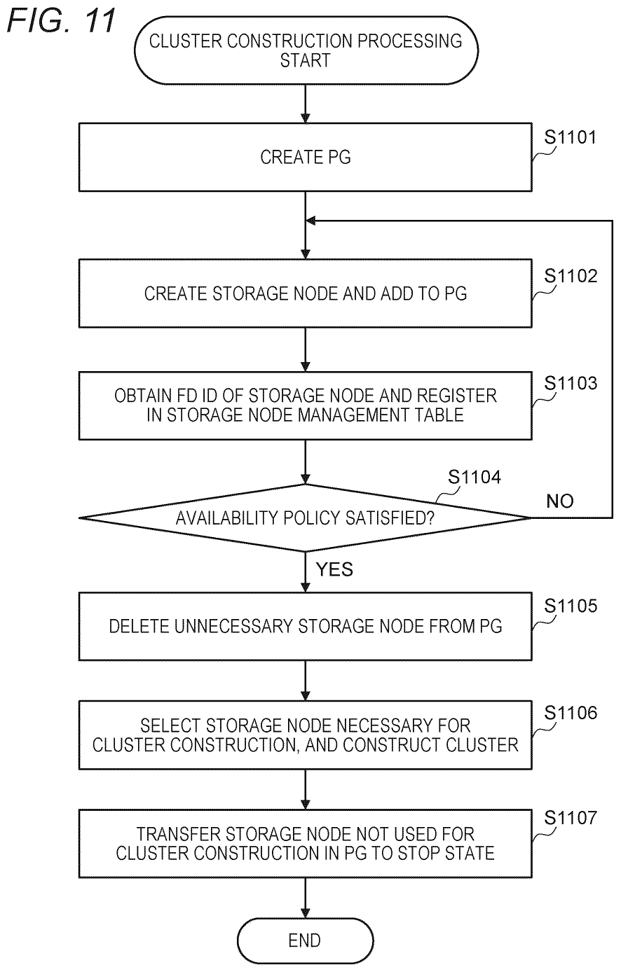

FIG. 11 is a flowchart illustrating cluster construction processing according to an embodiment.

The cluster construction processing may be started when an administrator (an example of a user) of the storage system 1 instructs the cloud control device 5.

The cloud control device 5 receives an instruction of PG creation through the interface provided to the administrator (for example, the host device 3 or the management device), and causes the computer-providing service 12 to execute the PG creation in response to the instruction (S1101). The administrator may be able to know the number of FDs 11 serving as the base of the PG. For example, the administrator may inquire of the cloud control device 5 about the number of FDs, and the cloud control device 5 may acquire the number of FDs from the computer-providing service 12 and return the number to the administrator.

The computer-providing service 12 creates (secures) the storage node 10 in the FD 11 and adds the storage node 10 to the PG 16 (S1102).

The created storage node 10 (for example, the cluster construction unit 35) acquires the FD ID of the FD 11 in which the storage node 10 exists (for example, acquires the FD ID from the computer-providing service 12 by making an inquiry to the computer-providing service 12), and registers the acquired FD ID in the record corresponding to the storage node 10 in the storage node management table 31 (S1103).

In the PG creation, the administrator may designate at least one of the number of FDs 11 across the created PG16 and the number of storage nodes 10 included in the PG16 (that is, the desired number for each of the FD 11 and the storage node 10). However, the administrator may not be able to designate in which FD 11 the desired number of storage nodes 10 are arranged. In which FD 11 the storage node 10 is created (secured) may be determined by the computer-providing service 12. For example, the computer-providing service 12 may create the storage node 10 in the FD 11 such that the storage nodes 10 are evenly distributed to the FDs 11 across the PG 16. In a case where the number of storage nodes 10 exceeding the number of FDs is generated, the administrator does not know which storage node 10 is generated in which FD 11. Therefore, there is technical significance in that the generated storage node 10 acquires the FD ID of the FD 11 in which the storage node 10 is generated and updates the storage node management table 31. In the redundant configuration recovery processing, the storage node 10 in the FD 11 different from the FD 11 in which the storage node 10 remaining in the cluster 15 exists is selected as the storage node 10 operating instead of the stopped storage node 10 on the basis of the storage node management table 31, and thus, it is possible to avoid aggregation of two or more storage nodes 10 in the cluster 15 in the same FD 11 and appropriately recover the redundancy.

The computer-providing service 12 determines whether or not the availability policy is satisfied (S1104). The availability policy may be associated with an instruction of PG creation (for example, an instruction from an administrator or an instruction from the cloud control device 5) or may be predetermined. The availability policy may include at least “there are a necessary number of storage nodes to constitute a cluster”. In addition, the availability policy may be a policy related to the number of FDs 11 serving as a base of the PG 16 and/or the number of storage nodes 10 constituting the PG 16, and may include, for example, at least one of the number of storage nodes 10 constituting the PG 16, the number of storage nodes 10 to be secured in one FD 11, and the necessary number of FDs and the necessary number of storage nodes. S1102 and S1103 are performed for each storage node 10 according to the availability policy. The availability policy may be determined in advance instead of being associated with the instruction.

When the determination result of S1104 is false (S1104: NO), the process returns to S1102. When the availability policy cannot be satisfied even if the retry of S1102 to S1104 is repeated for the specified number of times, the computer-providing service 12 may issue an alert and repeat the retry, may issue a notification indicating that the availability policy is not satisfied even if the retry is performed for the specified number of times to the administrator, may wait for a certain period of time until an appropriate storage node can be selected, or may abnormally end at this time point.

When the determination result in S1104 is true (S1104: YES), the storage node 10 unnecessary for the PG 16 is deleted by the computer-providing service 12 or any storage node 10 (for example, the cluster construction unit 35) necessary for the PG 16 (S1105). S1105 may not be performed.

One of the storage nodes 10 (for example, the cluster construction unit 35) in the PG 16 selects two or more storage nodes 10 in the PG 16 as an element of the cluster 15, and constructs the cluster 15 including the two or more selected storage nodes 10 (S1106). Each storage node 10 (for example, the cluster construction unit 35) in the cluster 15 updates the storage node management table 31 and the cluster management table 32 based on the configuration of the cluster 15. Note that the number of storage nodes 10 constituting the cluster 15 may be included in the availability policy. The storage nodes 10 constituting the cluster 15 may be uniformly selected from the FDs 11 across the PG 16. Therefore, in a case where the number of storage nodes 10 constituting the cluster 15 is equal to or less than the number of FDs 11 across the PG 16, the storage nodes 10 in different FDs 11 may be selected, and two or more storage nodes 10 in the same FD 11 may not be selected.

One of the storage nodes 10 in the cluster 15 (for example, the cluster construction unit 35 or the state changing unit 37) sets the state of the storage node 10 not included in the cluster 15 in the PG 16 to “Hibernated”, and updates the state 104 in the storage node management table 31 to “Hibernated” (S1107). For cost reduction, the OS disk capacity or the like of the “Hibernated” storage node 10 may be reduced.

The cluster configuration information 30 of all the storage nodes 10 in the created PG 16 may be the same information.

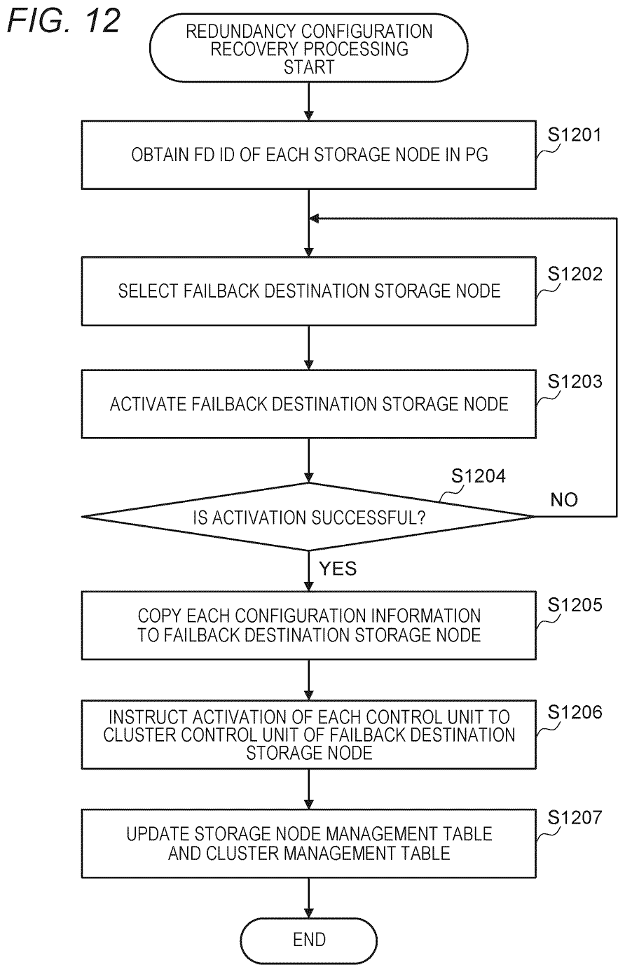

FIG. 12 is a flowchart illustrating redundant configuration recovery processing (at the time of storage node failure).

This processing is performed by at least the redundant configuration recovery unit 36 of the cluster control unit 33 and the redundant configuration recovery unit 36 of the representative storage node 10 in the cluster 15. In addition, it is assumed that the failover is completed at this time point, and thus, instead of the SC (Active) in the failed storage node 10 (the storage node 10 stopped due to a node failure), the SC (Standby) in the failback destination storage node 10 is promoted to the SC (Active) and operated.

The representative storage node 10 acquires the FD ID of each storage node 10 in the PG 16 including the cluster 15 from the storage node management table 31 (S1201). The “representative storage node 10” may be any storage node 10 in which a node failure does not occur in the cluster 15. Note that the representative storage node 10 may update the state 204 of the cluster 15 to “Failback in progress”.

The representative storage node 10 refers to the storage node management table 31 and the cluster management table 32, and selects any storage node 10 satisfying the following requirements (x) and (y) as the failback destination storage node 10 (S1202). The “failback destination storage node 10” is the storage node 10 that operates instead of the failed storage node 10.

(x)The cluster ID 101 is “Not Allocated” and the state 104 is “Hibernated”.

(y)It exists in the FD having the minimum number of storage nodes 202 among the FDs across the PG 16 including the cluster 15.

In principle, the failback destination storage node 10 may be selected from the FD 11 to which the storage node 10 to be stopped belongs. In a case where the failed storage node 10 is recovered at this time point, the recovered storage node 10 may be selected as the failback destination storage node 10. However, in S1202, it is checked whether the storage nodes 10 are evenly distributed to a plurality of FDs 11 across the PG 16, and in a case where a result indicating that the storage nodes are not evenly distributed is obtained, a storage node 10 (that is, the storage node 10 that contributes by the uniform distribution of the storage nodes 10) different from the recovered storage node 10 may be selected as the failback destination storage node 10. In addition, as will be described later, in a case where there is a spare FD 11, there may be a non-target FD 11 that is the FD 11 for which the failback destination storage node 10 should not be selected, and the failback destination storage node 10 may be selected from the FDs 11 excluding the non-target FD 11. When the availability deteriorates as a result of selecting the failback destination storage node 10 (for example, in a case where the number of storage nodes 10 exceeding the redundancy is concentrated in a specific FD 11, and cluster down occurs due to a single FD failure), the representative cluster control unit 33 may raise an alert (for example, update the state 204 of the cluster 15 to “Caution”) to continue the redundancy recovery processing, may notify the administrator of the deterioration in availability and ask the administrator to make a determination, may wait for a certain period of time until an appropriate failback destination storage node 10 can be selected, or may abnormally end at this time point.

The representative storage node 10 activates the failback destination storage node 10 selected in S1202 through, for example, the cloud control device 5 (S1203). As a result, the state 104 of the failback destination storage node 10 is updated from “Hibernated” to, for example, “Running”. In S1203, the configuration of the failback destination storage node 10 is updated as necessary. For example, when the OS disk capacity is reduced, the OS disk capacity may be increased. In addition, the storage device 13 detached from the failed storage node 10 is attached to the failback destination storage node 10.

When the startup of the failback destination storage node 10 has failed (S1204: NO), the process returns to S1202. That is, a different storage node 10 is selected as the failback destination storage node 10.

When the failback destination storage node 10 is successfully activated (S1204: YES), the representative storage node 10 copies the configuration information (for example, the cluster configuration information 30 including information for incorporating the failback destination storage node 10 into the cluster 15) from the failback destination storage node 10 (and/or the failed storage node 10) to the failback destination storage node 10 (S1205). The representative storage node 10 instructs startup of the cluster control unit 33 and the storage control unit 34 of the failback destination storage node 10 (S1206). The representative storage node 10 updates the storage node management table 31 and the cluster management table 32 (S1207). As a result, the failback destination storage node 10 is incorporated into the cluster 15, and the redundancy of the cluster 15 is recovered.

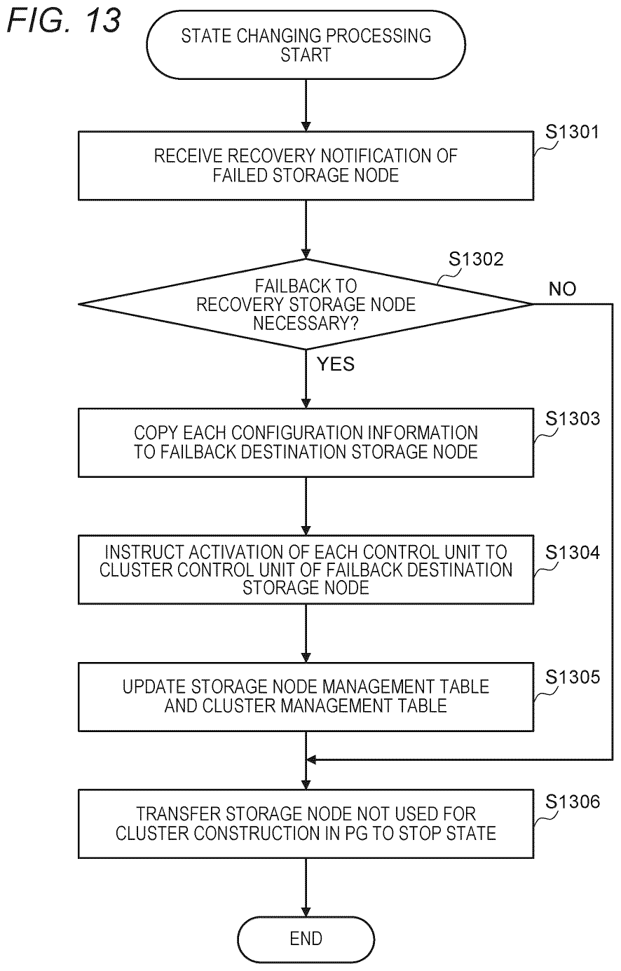

FIG. 13 is a flowchart illustrating state changing processing at the time of recovery of the failed storage node.

This processing is processing of changing the state of the failed storage node 10 when the failed storage node 10 is recovered.

The cloud control device 5 or the representative storage node 10 detects recovery of the failed storage node (S1301). For example, the cloud control device 5 or the representative storage node 10 may receive a notification from the cloud system 4, or may periodically check the state of the failed storage node 10 to confirm that it has become normal.

The cloud control device 5 or the representative storage node 10 determines whether or not it is necessary to fail back to the recovered storage node (S1302). For example, the cloud control device 5 or the representative storage node 10 determines whether or not there is a problem (“Caution”) that an inappropriate storage node is selected as the failback destination storage node 10 in the redundant configuration recovery processing (for example, as the storage nodes 10 in the cluster 15, there are a number of storage nodes exceeding the redundancy in the same FD 11), and the problem can be improved by performing failback to the recovered storage node (returning to the state before failure).

When the determination result of S1302 is true (S1302: YES), the representative storage node 10 (for example, the redundant configuration recovery unit 36 and/or the state changing unit 37) copies each configuration information from, for example, the original failback destination storage node to the failback destination storage node (recovery storage node) (S1303). The representative storage node 10 instructs startup of the cluster control unit 33 and the storage control unit 34 of the failback destination storage node 10 (S1304). The representative storage node 10 updates the storage node management table 31 and the cluster management table 32 (S1305). As a result, the recovered storage node 10 is incorporated into the cluster 15 instead of the original failback destination storage node 10.

The representative storage node 10 sets the state of the original failback destination storage node 10 to “Hibernated”, and updates the state 104 in the storage node management table 31 to “Hibernated” (S1306). For cost reduction, the OS disk capacity or the like of the “Hibernated” storage node 10 may be reduced.

The above is an example of processing performed in the present embodiment. Note that the configuration of the cluster 15 (for example, the number of nodes and the redundancy), the configuration of the plurality of FDs 11, the configuration of the PG 16, and the like are not limited to the above-described examples. For example, the example illustrated in at least one of FIGS. 14 to 17 may be adopted.

According to the example illustrated in FIG. 14, the number of nodes “6” and the redundancy “2” may be adopted for the cluster 15. According to the example illustrated in FIG. 14, the number of storage nodes required for the cluster 15 is larger than the number of FDs included (supported) in the cloud system 4. In this case, two or more storage nodes 10 in the same cluster 15 are aggregated in at least one FD 11. In the example illustrated in FIG. 14, since the number of FDs is “5” and the number of storage nodes 10 required for the cluster 15 is “6”, two storage nodes A and F in the same cluster 15 are aggregated into one FD 11.

In order to prevent cluster down due to a single FD failure, the redundancy of the cluster needs to be “2” or more, so it is conceivable to set the number of SCs constituting the redundancy group to 3 or more. For example, it is conceivable to set the storage control unit 34 not to Active-Standby but to Active-Standby-Standby. Although the FD fault tolerance decreases (availability decreases), the redundancy “1” may be adopted.

In the construction of the cluster 15, at least two storage nodes 10 are allocated to one of the FDs 11. Therefore, in the example illustrated in FIG. 14, for example, S1102 to S1104 in FIG. 11 are repeated until at least three storage nodes 10 are secured per FD 11 in the PG creation.

In the cluster construction, for example, a necessary number of storage nodes 10 are selected so that the storage nodes 10 can be distributed to as many FDs 11 as possible. In the example illustrated in FIG. 14, only the storage nodes A and F are aggregated in the same FD. At least one storage node (“Hibernated”) may be additionally secured in the FD 11 so that the failback destination storage node can be selected from the same FD 11 at the time of the simultaneous failure of the storage nodes A and F. A cluster 15 including the storage nodes A to F selected for cluster construction is constructed. In the PG 16, the state of each of the storage nodes G to O other than the storage nodes A to F is set to “Hibernated”.

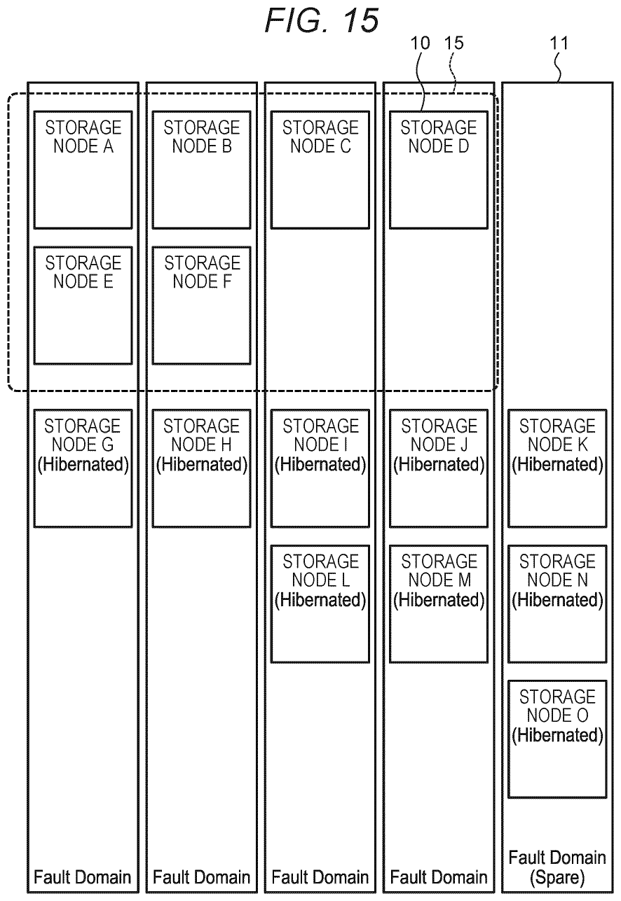

According to the example illustrated in FIG. 15, some FDs 11 (one or more FDs 11) of the plurality of FDs 11 included in the cloud system 4 are set as the spare FDs 11. The storage node 10 secured from the spare FDs 11 is not a component of the cluster 15. All the storage nodes 10 in the spare FDs 11 are spare storage nodes 10 (“Hibernated”). The number of storage nodes 10 secured in the spare FDs 11 may be the number of storage nodes in the FD 11 having the largest number of storage nodes among the other FDs 11, or the number of storage nodes in the cluster in the FD 11 having the largest number of storage nodes in the cluster 15 among the other FDs 11. Even if a node failure occurs in any storage node 10 in the cluster 15, the spare storage node 10 selected as the failback destination storage node 10 is the spare storage node 10 in the spare FD 11. As a result, it is possible to fail back all the storage nodes in the failed FD to the storage nodes in the spare FD when the FD failure occurs, so that the stability at the time of the FD failure is expected to be improved. According to the example illustrated in FIG. 15, when a failure occurs in the FD 11 including the storage nodes A and E, the storage nodes K and N in the spare FD 11 are failed back.

In the example illustrated in FIG. 15, in the PG creation, the storage node securing from each FD may be the same as in the example illustrated in FIG. 14. In the cluster construction, a necessary number of storage nodes 10 (for example, storage nodes A to F) are selected from FDs other than some FDs so that the storage nodes 10 can be distributed to as many FDs as possible other than some FDs. The “some FDs” in which the storage node 10 as an element in the cluster 15 is not selected at all are set as spare FDs. When a node failure occurs, the failback destination storage node is selected from FDs other than the spare FD.

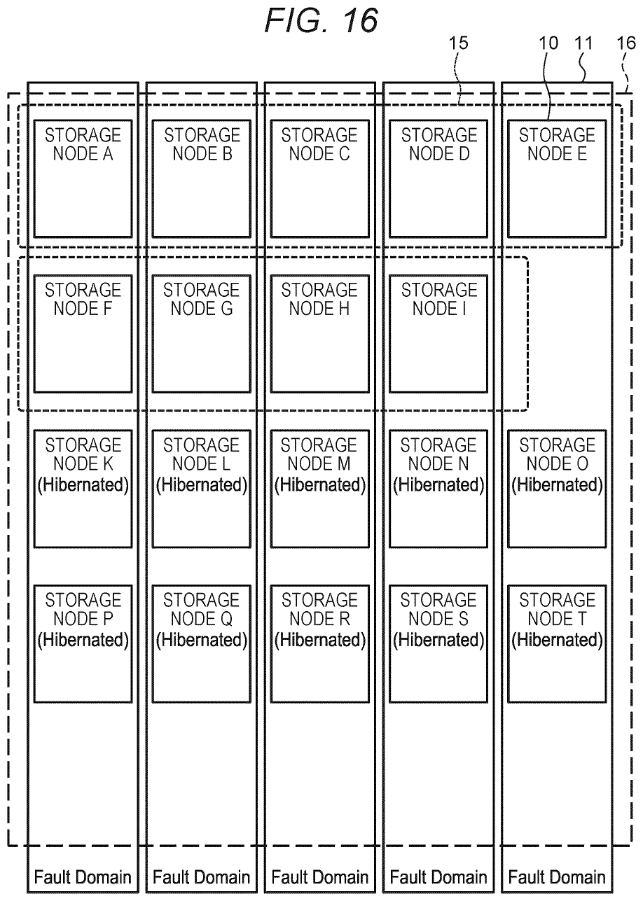

In the example illustrated in FIG. 16, a plurality of clusters 15 are included in one PG 16. The number of storage nodes 10 constituting each cluster 15 may be the same, but the number of storage nodes 10 constituting the cluster 15 may be different between clusters as illustrated in FIG. 16.

In addition, the spare storage node 10 in the PG 16 may be allocated to any cluster 15 and may be a spare storage node 10 dedicated to the allocated cluster, or may be common to a plurality of clusters 15. That is, each of the spare storage nodes K to T may be selected as the failback destination storage node 10 even if a node failure occurs in the storage node 10 in any of the cluster 15 including the storage nodes A to E and the cluster 15 including the storage nodes F to I. When each spare storage node 10 is shared by a plurality of clusters, the number of spare storage nodes 10 may be smaller than the number of storage nodes 10 constituting the plurality of clusters.

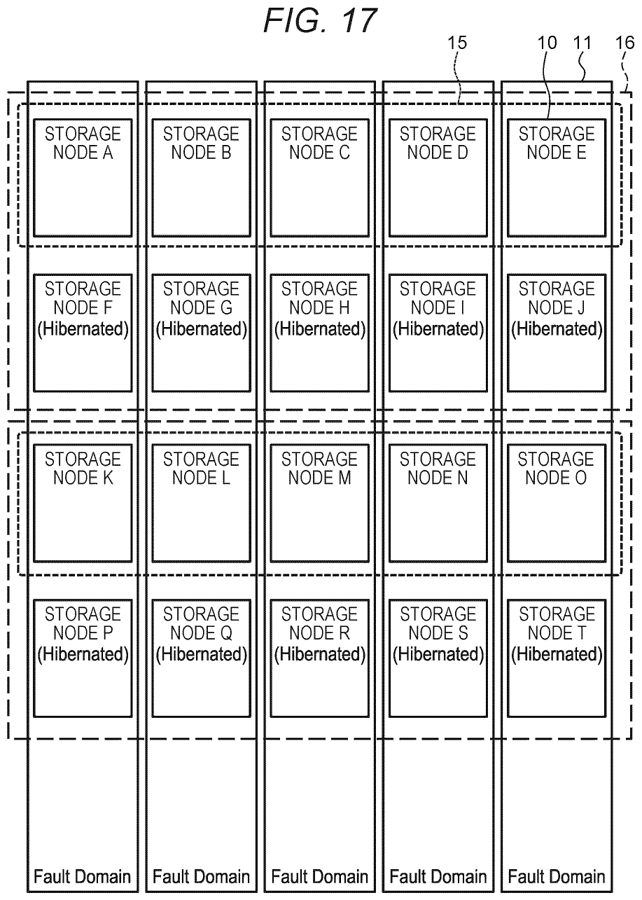

In the example illustrated in FIG. 17, the plurality of PGs 16 straddle the same FD group (the plurality of FDs 15). When a plurality of PGs 16 are prepared, the failback destination storage node 10 is secured in units of PGs. That is, when a node failure occurs in any of the storage nodes 10 in the cluster 15, the spare storage node 10 as the failback destination storage node 10 is selected from the PG 16 including the cluster 15. However, when the target cluster 15 supports the following functions, the “Hibernated” storage node 10 may be secured outside the PG 16, and the spare storage node 10 that can be selected as the failback destination storage node 10 may be shared between clusters (between PGs) as in FIG. 14.
The FD ID of the storage node 10 outside the PG 16 can be acquired.
An arbitrary storage node 10 outside the PG 16 can be incorporated into the PG 16 while maintaining the FD ID of the storage node 10 (for example, the FD 15 of the storage node 10 is not changed, or the FD ID is not changed even if the FD 15 of the storage node 10 is not changed).

Although one embodiment has been described above, this is an example for describing the present invention, and it is not intended to limit the scope of the present invention only to this embodiment. The present invention can also be implemented in other various forms, for example, a form in which a part of the configuration of each of the above-described embodiments is deleted, a form in which at least a part of the configuration is replaced, a form in which a configuration is added, and a combination of a part or all of each of the embodiments.

Note that the above description can be summarized as follows. The following summary may include supplementary description of the above description and description of modifications.

A plurality of storage nodes 10 configuring one or more PGs 16 (an example of one or more first storage node groups) across a plurality of FDs 11 in a cloud environment are provided. Specifically, for each of the one or more PGs 16, the FD ID (domain ID) of the FD 11 in which the storage node 10 is generated is acquired for each storage node 10, and the cluster 15 (an example of a second storage node group) is configured from a necessary number of storage nodes in which the domain IDs do not overlap as much as possible. Each storage node 10 included in the one or more clusters 15 is a member storage node 10, and the storage node 10 not included in any of the one or more clusters 15 is a spare storage node 10. Each member storage node 10 performs I/O with respect to the storage device 13 allocated to the member storage node 10, and holds cluster configuration information 30 (an example of the configuration information) including a correspondence relationship between the storage node 10 and the FD ID. Each spare storage node 10 is a storage node that can be selected based on the cluster configuration information 30 as a failback destination storage node to operate instead of the member storage node 10 when the member storage node 10 that stops due to an FD failure, a node failure, or the like exists in any one of the one or more clusters 15 or a predetermined cluster 15. For each of the one or more clusters 15, the number of member storage nodes 10 existing in the same FD 11 in the cluster 15 is equal to or less than the redundancy. The redundancy is the maximum number of member storage nodes allowed to stop simultaneously in the cluster 15. As a result, the availability of the storage system in the cloud environment can be appropriately maintained.

The plurality of storage nodes 10 constituting the PG 16 across the plurality of FDs 11 may be provided by at least one of one or more computers (for example, the cloud control device 5, the computer-providing service 12, and one or more storage nodes 10). For each storage node 10 generated (secured) in the FD 11, the storage node 10 may acquire the FD ID of the FD 11 to which the storage node 10 belongs, and add the relationship between the storage node 10 and the acquired FD ID to the cluster configuration information 30. One or more clusters 15 may be configured based on the plurality of storage nodes 10 generated by at least one of the one or more computers and the FD IDs of the plurality of storage nodes, and the storage nodes 10 not included in any cluster 15 may be set as the spare storage nodes 10. In order to construct the cluster 15, the storage nodes 10 in the number equal to or more than necessary for constructing the cluster 15 may be secured in advance by at least one of the one or more computers, a necessary number of storage nodes 10 may be selected so that the number of overlapping FD IDs is equal to or less than the redundancy of the cluster 15, and the cluster 15 may be constructed from the selected necessary number of storage nodes 10.

The state of the spare storage node 10 may be a state of hibernation as a stop state in which activation of the spare storage node 10 is required for operation of the spare storage node 10 but power consumption is small. This allows the storage system to be maintained at low cost (with small power consumption). From another point of view, the state of the spare storage node 10 may be a state in which the ID of the PG 16 including the spare storage node 10 and the domain ID of the FD 11 in which the member storage node 10 is disposed are allocated to the spare storage node 10 in the cluster configuration information 30, but the ID of any cluster 15 is not allocated. Each spare storage node 10 may be brought into a hibernation state by at least one of the one or more computers, for example, through a predetermined function in a cloud environment (for example, a function provided by a cloud vendor).

When the storage node 10 in any cluster 15 is stopped, the representative storage node 10 which is any storage node 10 other than the stopped storage node 10 in the cluster 15 may select any spare storage node 10 as the failback destination storage node 10 based on the cluster configuration information 30, and the selected spare storage node 10 may be set as the member storage node 10 of the cluster 15 instead of the stopped storage node 10. Specifically, based on the cluster configuration information 30, the representative storage node 10 may select the spare storage node 10 in the FD 11 in which the number of member storage nodes 10 in the cluster 15 is maintained to be equal to or less than the redundancy of the cluster 15 for any FD 11 as the failback destination storage node 10. For example, the FD ID of the FD 11 to which the stopped storage node 10 belongs is specified from the cluster configuration information 30, and any one of the spare storage nodes 10 may be selected as the failback destination storage node 10 so that the FD fault tolerance does not decrease (so that the redundancy of the cluster 15 is recovered). Accordingly, availability can be maintained.

One or more FDs 11 of some of the plurality of FDs 11 may be one or more spare FDs 11. For each of the one or more spare FDs 11, when one or more storage nodes 10 are arranged in the spare FD 11, the one or more storage nodes 10 may not be selected as an element of any cluster 15 by at least one of the one or more computers, and may be set as the spare storage nodes 10. The representative storage node 10 may select the spare storage node 10 as the failback destination storage node 10 from one or more spare FDs 11. As a result, in a case where the FD failure occurs, all the storage nodes 10 in the failed FD 11 can fail back to the storage nodes 10 in the spare FD 11, so that the stability at the time of the FD failure is expected to be improved.

The at least one PG 16 may include two or more clusters 15 and one or more spare storage nodes 10 common to the two or more clusters 15. When the storage node 10 in one of the two or more clusters 15 stops, the representative storage node 10 may select one of the one or more common spare storage nodes 10 as the failback destination storage node 10. As a result, it can be expected that the number of spare storage nodes 10 is saved and resource consumption is suppressed.

The spare storage node 10 may be dynamically secured (for example, at the time of failback), but for at least one of the one or more PGs 16, the one or more spare storage nodes 10 may be secured in advance before the storage node 10 in any cluster 15 stops. As a result, it can be expected that the spare storage node is reliably secured from the FD 11 in which the FD fault tolerance does not decrease (the redundancy of the cluster 15 is recovered). In other words, it can be expected to eliminate the possibility that the failback destination storage node cannot be secured from the FD 11 because the FD 11 is used in the member storage node 10 of another user, for example.

What is claimed is:

1. A storage system comprising a plurality of storage nodes constituting one or more first storage node groups across a plurality of fault domains in a cloud environment, wherein
for each of the one or more first storage node groups, a domain ID of a fault domain in which the storage node is generated is acquired for each storage node,
a second storage node group is configured from a necessary number of storage nodes having domain IDs that do not overlap as much as possible,
each storage node included in one or more second storage node groups is a member storage node, and a storage node not included in any of the one or more second storage node groups is a spare storage node,
each member storage node is configured to perform I/O with respect to a storage device allocated to the member storage node, and holds configuration information including a correspondence relationship between a storage node and a domain ID,
each spare storage node is a storage node that can be selected, when a member storage node to be stopped is in any one of the one or more second storage node groups or a predetermined second storage node group, on a basis of the configuration information as a failback destination storage node to operate instead of the member storage node, and
for each of the one or more second storage node groups, the number of member storage nodes existing in the same fault domain among the second storage node groups is equal to or less than a redundancy, and the redundancy is a maximum number of member storage nodes allowed to stop at the same time among the second storage node groups.

2. The storage system according to claim 1, wherein a state of the spare storage node is a state of hibernation as a stop state in which activation of the spare storage node is required for operation of the spare storage node but power consumption is small.

3. The storage system according to claim 2, wherein a state of the spare storage node is a state in which an ID of a first storage node group including the spare storage node and a domain ID of a fault domain in which the spare storage node is disposed are allocated to the spare storage node in the configuration information, but no ID of any second storage node group is allocated to the spare storage node.

4. The storage system according to claim 1, wherein when a storage node in any of the second storage node groups is stopped, a representative storage node which is any storage node other than the storage node to be stopped in the second storage node group,
selects any spare storage node as a failback destination storage node based on the configuration information, and
sets the selected spare storage node as a member storage node of the second storage node group instead of the storage node to be stopped.

5. The storage system according to claim 4, wherein the representative storage node selects the spare storage node in a fault domain in which the number of member storage nodes of the second storage node group is maintained to be equal to or less than the redundancy of the second storage node group for any fault domain as a failback destination storage node based on the configuration information.

6. The storage system according to claim 4, wherein
one or more fault domains as a part of the plurality of fault domains are one or more spare fault domains,
when one or more storage nodes are arranged in the spare fault domain for each of the one or more spare fault domains, the one or more storage nodes are all spare storage nodes and are not selected as elements of any second storage node group, and
the representative storage node selects a spare storage node as the failback destination storage node from the one or more spare fault domains.

7. The storage system according to claim 4, wherein
at least one first storage node group includes two or more second storage node groups and one or more spare storage nodes common to the two or more second storage node groups, and
when a storage node in one of the two or more second storage node groups stops, the representative storage node selects one of the one or more common spare storage nodes as the failback destination storage node.

8. The storage system according to claim 4, wherein for at least one of the one or more first storage node groups, the one or more spare storage nodes are reserved in advance before a storage node in any of the second storage node groups stops.

9. A system construction method, comprising:
generating a plurality of storage nodes constituting one or more first storage node groups in a storage system across a plurality of fault domains in the plurality of fault domains in a cloud environment, and acquiring a domain ID of a fault domain in which the storage node is generated for each storage node in generation of the plurality of storage nodes; and
constituting a second storage node group from the necessary number of storage nodes in which domain ids are not overlapped as much as possible, wherein
for each of the one or more first storage node groups,
each storage node included in one or more second storage node groups is a member storage node, and a storage node not included in any of the one or more second storage node groups is a spare storage node,
each member storage node is configured to perform I/O with respect to a storage device allocated to the member storage node, and holds configuration information including a correspondence relationship between a storage node and a domain ID,
each spare storage node is a storage node that can be selected, when a member storage node to be stopped is in any one of the one or more second storage node groups or a predetermined second storage node group, on a basis of the configuration information as a failback destination storage node to operate instead of the member storage node, and
for each of the one or more second storage node groups, the number of member storage nodes existing in the same fault domain among the second storage node groups is equal to or less than a redundancy, and the redundancy is a maximum number of member storage nodes allowed to stop at the same time among the second storage node groups.

10. The system construction method according to claim 9, further comprising setting a state of each of the member storage nodes to a state of hibernation as a stop state in which activation of the member storage node is required for operation of the member storage node but power consumption is small.

11. The system construction method according to claim 10, wherein a state of each of the member storage nodes is a state in which an ID of a first storage node group including the member storage node and a domain ID of a fault domain in which the member storage node is disposed are allocated to the member storage node in the configuration information, but no ID of any second storage node group is allocated to the member storage node.

12. The system construction method according to claim 9, further comprising:
when a storage node in any of the second storage node groups is stopped,
selecting, by a representative storage node which is any storage node other than the storage node to be stopped in the second storage node group, any spare storage node as a failback destination storage node based on the configuration information; and
setting the selected spare storage node as a member storage node of the second storage node group instead of the storage node to be stopped.

13. The system construction method according to claim 12, further comprising selecting, by the representative storage node, the spare storage node in a fault domain in which the number of member storage nodes of the second storage node group is maintained to be equal to or less than the redundancy of the second storage node group for any fault domain as a failback destination storage node based on the configuration information.

14. The system construction method according to claim 12, further comprising:
when one or more fault domains as a part of the plurality of fault domains are one or more spare fault domains, and
one or more storage nodes are arranged in the spare fault domain for each of the one or more spare fault domains,
selecting none of the one or more storage nodes as an element of any second storage node group, and setting the one or more storage nodes as spare storage nodes; and
selecting, by the representative storage node, a spare storage node as the failback destination storage node from the one or more spare fault domains.

15. The system construction method according to claim 12, further comprising:
preparing, for at least one first storage node group, for two or more second storage node groups, one or more spare storage nodes common to the two or more second storage node groups; and
selecting, when a storage node in any of the two or more second storage node groups stops, by the representative storage node, one of the one or more common spare storage nodes as the failback destination storage node.
